(19) United States
(12) Patent Application Publication
(10) Pub. No.: US 2006/0081249 A1
(43) Pub. Date: Apr. 20, 2006

(54) Personal respirator

(76) Inventor: James N. Duxbury, Graham, NC (US)

Correspondence Address: HARNESS, DICKEY & PIERCE, P.L.C., P.O. BOX 8910, RESTON, VA, 20195, US

(21) Appl. No.: 11/292,102

(22) Filed: Dec. 2, 2005

Related U.S. Application Data
(63) Continuation of application No. 10/460,465, filed on Jun. 13, 2003, now abandoned.
(60) Provisional application No. 60/395,266, filed on Jul. 15, 2002.

(51) Int. Cl. A62B 23/02; A62B 7/10

(52) U.S. Cl. 128/205.27; 128/206.11

(57) ABSTRACT

This Personal Respirator is a respiratory protection air-purifying device that minimizes the area required in front of the face, especially around the mouth area, by locating the very lightweight filter and plenum close to the head, connected by a airway tube forming a complete unit with the mouthpiece in the mouth, supported by the mouth. The airway tube and the filter plenum are both of minimal internal area and close to the mouthpiece, thus minimizing the internal volume of used air, residual nitrogen, and making the outside dimensions small enough to be compatible with most safety equipment. The respirator requires no straps and is preferably provided with a small tether to the nose clip and is worn in front of the head with the mouthpiece inserted into the mouth, the filter then supported by the mouth, and the nose clip secured on the nose.

This is a non-provisional of provisional application Ser. No. 60/395,266, filed Jul. 15, 2002, the contents of which are incorporated herein in their entirety.

### BACKGROUND OF INVENTION

Personal respiratory protection has been recommended and required by both government and industry for many years. Studies have been made, standards set, and filtration developed to enable a worker to function in contaminated air with relative safety. However, due to the discomfort, cost, and restrictiveness of the respirator facemask, respirators are only worn when absolutely necessary and in many cases, hamper the capabilities and safety of the wearer. Respirators are also hot and heavy to wear, exerting pressure on sensitive areas of the face. They are impossible to wear properly with facial hair, sensitive skin, deep scars, or facial deformities. Respirators protrude in front of the face, limiting visibility and trapping large amounts of exhaled air that condenses on the face. The excessive dead air space, the space between the mask and face, traps exhaled air.

This air is hot, condenses on the face and is rebreathed when the wearer inhales. Thus the trapped air enters the lungs before any fresh filtered air and mixes with the residual air remaining in the lungs after exhalation. The retained carbon dioxide level in the lungs then rises, possibly resulting in hyperventilation, diminished capacity to perform work, and cardiac stress.

It is therefore an objective of this invention to address these conditions with structure designed to eliminate or minimize one or more of the above-noted problems. This will lead to greater comfort and safety for the user and consequently result in a greater likelihood that the user will wear the protective device and realize its benefits.

### SUMMARY OF THE INVENTION

This Personal Respirator is a respiratory protective filtration device. According to one embodiment, it includes of a mouthpiece that is a curved rubber-type flange. The mouthpiece is held in the user's mouth between the lips, in front of the teeth, with a tubular airway extending from it, into a thin disk plenum frame covered on the front and back with an air permeable filter media. Because the plenum is streamlined, of minimal thickness, and only open to the adjacently attached mouthpiece, the volume of dead air space contained, can be limited to less than 25 milliliters. Such volume is substantially below most existing respirators.

When the user inhales, air is drawn in through the air permeable filter media, into the plenum and further directed through the airway tube, past the mouthpiece, into the lungs. Exhaling is the exact opposite and disperses the breath below the nose, through both the front and back air permeable filters.

This eliminates the fogging of glasses, safety glasses, or goggles and takes with the exhaled breath, any condensate that might have collected. The air permeable filter material is a type selected to remove the particular contaminants in the area in which the respirator is to be worn. It may be a purchased item of known design. The media is intended to be of a lightweight material, such as the nuisance dust type or a version of the N, R, or P filter media as defined in the Federal Register's, Department of Health and Human Services, 42 CFR, Part 84, Respiratory Protective Devices, Subpart K, Paragraph 84.170, (b). This media is bonded directly to the plenum frame to make a maintenance free, low cost respirator. In other cases the filter media could be molded to a shape forming the plenum area. Other models could have the filter media clamped, with holding frames, to the plenum's outer periphery, so that it could be replaced when needed, or a completely replaceable filter and plenum cartridge with a snap-on/snap-off, threaded or twist-lock type socket, preferably gasketed to a mouthpiece adapter. Additionally, any of these configurations could have an exhaust check valve sealed into the air permeable filter media itself. A nose clip is tethered to the respirator. The nose clip installs over the nose insuring that the nostrils are safely closed airtight.

With this design, obstruction of the wearer's vision by the facemask and filter is substantially reduced or altogether eliminated, making it a definite improvement in safety to the operator. Supporting straps and elastic bands around the head are also eliminated, making it totally compatible with the wearing of a hard hat, winter clothing, safety equipment, adding greatly to the convenience and comfort factors. When needed, the respirator mouthpiece is placed into the mouth and the nose clip is installed on the nose. This forms a positive seal to the face and can be worn with facial hair, deep scars, or deformed facial features, and does not irritate facial tissue. The front of the respirator is designed to be close to the face, which enables it to be worn with safety equipment, welding helmets, or full-face shields without (or minimally) restricting visibility or without sacrificing functionality.

This invention addresses with a simple design, the problems that exist with respirators currently being used. By being more compatible and user friendly, the wearer will use the respirator longer without discomfort and be able to function in a safer manner. These advantages and objectives of the invention will be more fully apparent by reference to the drawings, briefly described hereafter, and the detailed description of the preferred embodiments of the Personal Respirator thereafter.

### BRIEF DESCRIPTION OF DRAWINGS

FIG. 1 is a side view of the respirator in accordance with one embodiment of the present invention.

FIG. 1A is a side view of the respirator and a nose clip being worn by a user 10 held between the lips with the mouthpiece shown between the lips 20 and teeth 30.

FIG. 2 is a plan view of the respirator in accordance with one embodiment of the present invention.

FIG. 3 is a cross-sectional view of the device of FIG. 2 taken along line 3-3.

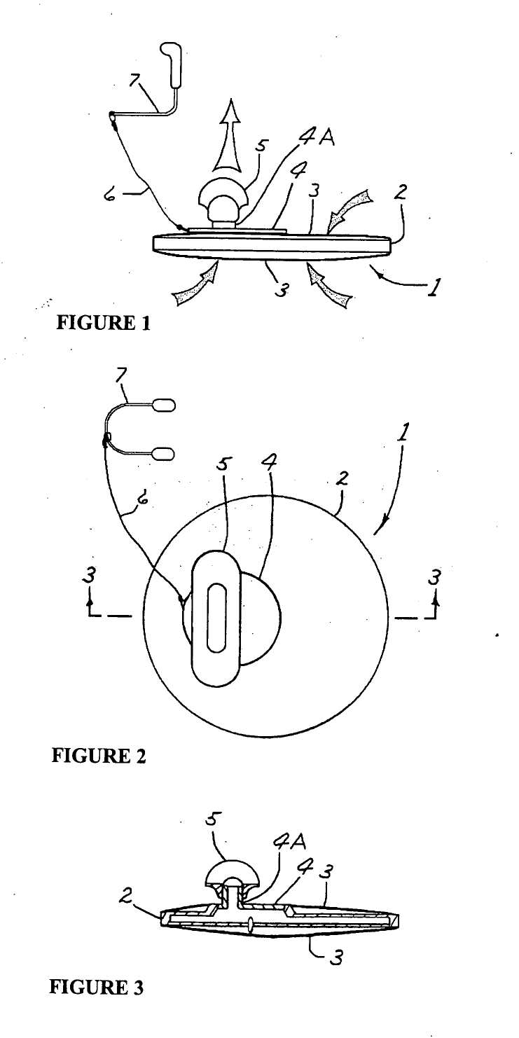

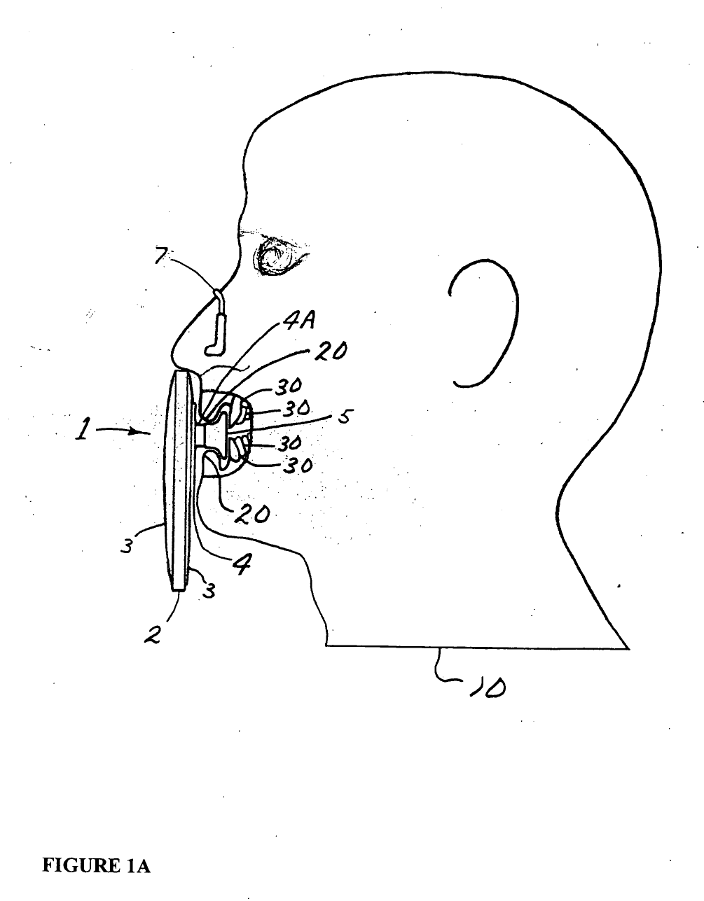

Note that FIGS. 1, 1A, 2 and 3 are not necessarily drawn to scale.

### DETAILED DESCRIPTION OF THE PREFERRED EMBODIMENT(S)

Referring to FIG. 1, a personal respiratory protection device is designated by the numeral 1. Device 1 is simply installed by placing mouthpiece 5 in the mouth and the nose clip 7 on the nose.

The mouthpiece is designed to interconnect the device 1 to the user. While this mouthpiece 5 can be of many forms, in the embodiment shown, it is substantially an oval flange having its longitudinal axis substantially in line with the longitudinal axis of the user's mouth (i.e., horizontally between the lips).

Preferably, the mouthpiece 5 is made of a soft, food grade type material, like silicone, shaped so that when inserted into the mouth between the lips, anterior and adjacent to the teeth, the wearer's lips press down on the air tube 4 (includes tube parts 4 and 4A), (see FIG. 1A) providing a seal, support, and an airway from mouthpiece 5 to the filter plenum 2. This configuration allows the mouth to close and function normally. With the mouth closed, the swallowing process can take place, thus preventing saliva from draining from the mouth through the air tube 4A and into the filter plenum 2. The substantially oval flange surrounding the mouthpiece 5 (see FIG. 2) aids in the passage of air through the mouthpiece by blocking incidental air, which would otherwise escape between the lips of the user and the mouthpiece. It has been found that a smaller flat flange works better than larger flat flanges by conforming and sealing to the mouth of the user. According to one embodiment, the oval air tube 4A is made of a PVC type material, approximately ½ inch long with about a 1/32 inch wall thickness and about a 1⅛ inch wide by ¼ inch high internal free open area: This allows for a typical user to inhale and exhale without adverse restriction or backpressure. This is to be preferred. In other embodiments, a modified mouthpiece from about 1/32 inch and to about 1 inch thick with curved or flat flanges (possibly of rigid, flexible or semi-flexible material) and either oval, round, rectangular, square, triangular, elliptical or other shaped air tube(s), may be warranted in order to optimally interconnect the device to the mouth of the user.

The air tube 4A is to be of minimal length and internal volume, and connects the opening of mouthpiece 5 to the back of filter plenum 2. It is desired that this filter plenum be located as close to the mouthpiece as possible, preferably less than about 2 inches, to minimize the volume of previously utilized air, and residual nitrogen. This is also why plenum 2 is of minimal thickness, preferably from about 1/16 inch to about 1 inch between the front and back surfaces that holding air permeable filter media 3, (see FIG. 3).

According to one embodiment of the present invention, plenum 2 is shown as a circular frame and made of plastic, with web spacers, radiating outward from the air tube 4. The frame is open on both sides to the air permeable filter media 3. This is to be preferred. In other embodiments, the plenum may be any sealed area between the air permeable filter media and attached to the air tube, and could even be molded into the media itself. Also an oval, square, triangular, rectangular, or elliptical shaped plenum 2 and air permeable filter media 3 may be used. Other shapes are also contemplated to be within the scope of this invention as would be understood by one of ordinary skill in the art. When the wearer inhales, air is drawn in and filtered through the air permeable filter media 3. This filter media may be commercially available, of known design, selected, and purchased to remove the particular contaminants deemed hazardous to the wearer. The filter media 3 is bonded air tight to both sides of plenum 2.

This bonded media is to be preferred in the disclosed embodiment. In other embodiments, the filter media 3 could be clamped to plenum 2 with holding frames, so that it could be replaced when needed, molded or formed to create the sealed plenum space, or a completely replaceable filter cartridge gasketed to an adapter with the air tube may be preferred. According to one embodiment, an air permeable filter suitable for use in connection with the present invention is described as P/N DISKIT-N99, U.S. SAFETY NIOSH N99 filter cartridge. A fuller description of this filter cartridge is provided in U.S. Pat. No. 5,732,695 incorporated herein by reference in its entirety for all purposes.

This forms the very lightweight (air permeable filter 3, plenum 2, air tube 4 and 4A, and mouthpiece 5) respirator, assembly 1, which is supported on the mouth. According to one embodiment of the present invention, the total weight of the respiratory device should represent a lightweight amount.

In particular, such lightweight amount is one that is sufficient for a user of the respiratory device to balance, and/or support the same while maintaining an airtight seal when held between the lips and in front (i.e., anterior) of the user's teeth (includes dentures, gums etc. depending on the physical condition of the user's mouth). Thus, for example, it is desirable that the total weight of the respiratory filtration device is less than about 5 ounces. Accordingly, the total weight of the respiratory filtration device (including the weight of the air permeable filter(s), any plenum(s), any connector(s), any mouthpiece flange(s)) may be less than about 4 ounces, 3 ounces, 2 ounces or even less than 1 ounce. In this way, a respiratory filtration device is provided having a total weight that a user can hold and use in his/her mouth for an extended period of time without causing substantial or any discomfort or fatigue while being comfortable to use. Also this configuration removes the bulky facemask from obstructing the wearer's vision, making it a definite improvement in safety to the operator. Supporting straps and elastic bands around the head are also not required, making it gender free, compatible with wearing a hard hat, safety equipment, winter clothing, and adds greatly to various convenience and comfort factors. The mouthpiece, when inserted, forms a positive seal to the users mouth itself and can be worn with large growths of facial hair, deep scars, deformed facial features, and does not irritate facial tissue. The front of the respirator is designed to be close to the face, which enables it to be worn with safety equipment, welding helmets, or full-face shields without restricting visibility or functionality.

The nose clip 7 (see FIGS. 1 & 2) is used to clamp the nostrils airtight. According to one embodiment, it may be a purchased item of known design. Also, the tether 6 may be a purchased item of known design and used to insure that the nose clip is available when needed.

With the nose clip 7 clamping the nostrils closed and mouthpiece 5 properly inserted into the wearer's mouth, a positive seal is made to the user and unlike half mask respirators, can be worn with a full beard, deep scars and facial deformities. It also does not trap dead air and condensate against the user's face causing skin irritation, discomfort and consequently, lack of use.

While preferred embodiments and particular applications of this invention have been shown and described, it is apparent to those skilled in the art that many other modifications and applications of this invention are possible without departing from the inventive concepts herein.

For example, it should be understood that while the personal respiratory device is shown in the drawings as having a single, circular, filter configuration, the personal respirator device may use different size filters, or different shapes, such as rectangular, octagon, or elliptical with a compatible air tube and mouthpiece to be suitable for the purpose of the invention.

It is, therefore, to be understood that, within the scope of the appended claims, this invention may be practiced otherwise than as specifically described, and the invention is not to be unduly restricted. Though some of the features of the invention may be claims in dependence, each feature has merit if used independently.

All patents, publications or other references cited in this application are incorporated herein by reference in their entirety for all purposes.

1. A respiratory filtration device for use in a human mouth having lips and teeth, said device comprising:
a) a hollow connector having a first air filtration end and a second air mouthpiece end; and
b) an air permeable filter sealing said first air filtration end
wherein said second air mouthpiece end has a size and a shape sufficient to form an airtight seal when held anterior to said teeth between lips in said mouth.

2. The device of claim 1 wherein said air permeable filter further comprises:
a plenum sealed with a first filter membrane and optionally with a second filter membrane.

3. The device of claim 1 further comprising a nose clip for preventing inhalation through a human nose.

4. The device of claim 1 wherein said air permeable filter is removably attached to said connector.

5. The device of claim 1 wherein said connector has a length from said first air filtration end to said second air mouthpiece end of about 2 inches or less.

6. The device of claim 2 wherein said air permeable filter together with said plenum are removably attached to said connector.

7. The device of claim 4 wherein air permeable filter is attached to said connector via an airtight connection.

8. The device of claim 7 wherein said airtight connection is a gasket.

9. The device of claim 6 wherein said air permeable filter is attached to said connector via an airtight connection.

10. The device of claim 9 wherein said airtight connection is a gasket.

11. The device of claim 1 wherein said second air mouthpiece end comprises a mouthpiece flange in airtight seal with said second air mouthpiece end wherein said mouthpiece flange has a curved and flat shape sufficient to rest anterior and adjacent to said teeth behind said lips to form an airtight seal.

12. The device of claim 2 wherein said second air mouthpiece end comprises a mouthpiece flange in airtight seal with said second air mouthpiece end wherein said mouthpiece flange has a curved and flat shape sufficient to rest anterior and adjacent to said teeth behind said lips to form an airtight seal.

13. The device of claim 2 wherein said air permeable filter and its plenum together have a total thickness which is less than about 1 inch.

14. The device of claim 1 wherein said hollow connector has an interior opening forming an essentially oval, square, rectangular, triangular, round, or elliptical shape.

15. The device of claim 2 wherein said hollow connector has an interior opening forming an essentially oval, square, rectangular, triangular, round, or elliptical shape.

16. The device of claim 1 wherein said device has a total weight of less than about 5 ounces.

17. The device of claim 16 wherein said device has a total weight of less than about 1 ounce.

18. The device of claim 2 wherein said device has a total weight of less than about 5 ounces.

19. The device of claim 2 wherein said device has a total weight of less than about 1 ounce.

20. The device of claim 1 wherein said air permeable filter comprises a paper filter and said hollow connector comprises a plastic connector.

21. The device of claim 2 wherein said air permeable filter comprises a paper filter, said hollow connector comprises a plastic connector and said plenum comprises a plastic spacer.

22. The device of claim 1 wherein said air permeable filter is a disposable filter.

23. The device of claim 2 wherein said air permeable filter is a disposable filter.

24. The device of claim 1 wherein said air permeable filter is removably attached to said connector via a threaded and optionally gasketed connection.

25. The device of claim 1 wherein said air permeable filter is removably attached to said connector via a twist-lock and optionally gasketed connection.

26. The device of claim 1 wherein said air permeable filter is removably attached to said connector via a snap-on/snap-off lock and optionally gasketed connection.

27. The device of claim 2 wherein said air permeable filter together with said plenum are removably attached to said connector via a threaded and optionally gasketed connection.

28. The device of claim 2 wherein said air permeable filter together with said plenum are removably attached to said connector via a twist-lock and optionally gasketed connection.

29. The device of claim 2 wherein said air permeable filter is removably attached to said connector via a snap-on/snap-off lock and optionally gasketed connection. inhalation through a human nose.
